(19) United States
(12) Patent Application Publication
(10) Pub. No.: US 2012/0243068 A1
(43) Pub. Date: Sep. 27, 2012

(54) ELECTROCHROMIC APPARATUS

(75) Inventors: YU-CHOU YEH, TAOYUAN COUNTY (TW); CHAO-YI WANG, TAOYUAN COUNTY (TW); WEN-CHIH LO, TAOYUAN COUNTY (TW); TSUNG-HER YEH, New Taipei City (TW)

(73) Assignee: J TOUCH CORPORATION, TAOYUAN COUNTY (TW)

(21) Appl. No.: 13/165,755

(22) Filed: Jun. 21, 2011

(30) Foreign Application Priority Data
Mar. 25, 2011 (TW) 100110339

(51) Int. Cl. G02F 1/153

(52) U.S. Cl. 359/275

(57) ABSTRACT

Disclosed herein is an electrochromic apparatus. In particular, the apparatus is a multi-layer structure mainly having transparent glass substrates. An aerogel with multiple holes is packaged within the structure. The conducting materials are coated on the substrates. An electrochromic material is then packaged within the layers of conducting materials. By applying voltage onto the conducting materials, the property of electrochromic material may be changed, such as changing its transparency or color. Further, photocatalyst material may be coated upon the outside surfaces of the substrates. A solar energy power layer may be disposed on the substrate for supplying power to the apparatus or to others. In accordance with one further embodiment, an electrochromic composite material may be employed into the apparatus, especially packaged within the substrates. The composite material is made of the aerogel and the electrochromic material.

### BACKGROUND OF THE INVENTION

1. Field of the Invention

The instant disclosure is related to an electrochromic apparatus, more particularly to a transparency-changeable electrochromic apparatus with application of voltage.

2. Description of Related Art

According to description of the conventional electrochromic technology, the reflectivity, transmittance, and absorptivity of the material may be altered when placed under an external electric field. This kind of electrochromic material may be applied to provide a stable and reversible color change. For example, the material with application of electric field may be changed from colored to transparent.

The electrochromic material may roughly be categorized into an inorganic electrochromic material and an organic electrochromic material. Typical type of the inorganic electrochromic material is tungsten trioxide. The composition of typical organic electrochromic material mainly includes Polythiophene class and its derivatives, Viologen class, Tetrathiafulvalene, metal Phthalocyanine class.

An intelligent glass may be formed since the electrochromic material is applied to the ordinary window. The optical absorptivity and transmittance of the intelligent glass is adjustable in response to an electric field. This intelligent glass may be selectively used to absorb or reflect the external thermal radiation or internal heat diffusion. The indoor temperature, illumination of natural light are therefore adjustable. The purpose of anti-glare is also achieved.

The electrochromic material allows comprehensive applications. One of the applications is for the glass mounted on a door or window. Reference is made to FIG. 1 related to U.S. Pat. No. 7,333,258, published on Feb. 19, 2008, describing an electrochromic apparatus.

FIG. 1 describes an electrochromic apparatus equipped with a first transparent electrode layer 13, a second transparent electrode layer 14, an electrochromic layer 10, an ion-conductive layer 15, and an ion-storage layer 16, which are placed between a first a first glass plate 11 and a second glass plate 12. The electrochromic apparatus is particularly applied to windows. The electrochromic apparatus further includes a voltage source 18 connected to both the first and second transparent electrode layers 13, 14.

Since power through the voltage source 18 is applied to the first transparent electrode layer 13 and the second transparent electrode layer 14, the ions there-between move to the electrochromic layer 10 from the ion-conductive layer 15. Reversely, the ions may also move to the ion-conductive layer 15 from the electrochromic layer 10. The property of material of the electrochromic layer 10 results in the change of the layer, especially to colors, darkness, or transparency.

Some topics related to the electrochromic glass device may be raised. For example, the electrochromic glass device may not effectively be heat-insulated. Also, the surface of outside glass may easily be contaminated, and hard to wash, especially at the tall building. Such as the outdoor glass usually exposed to the sun for a long time, the electrochromic-related device may be integrated with the solar energy technologies.

### SUMMARY OF THE INVENTION

Currently, there are few patents or prior technologies mentioning the advantages of the composite which combines the aerogel layer with property of High dielectric constant and the electrochromic layer. In view of the properties of the mentioned materials, the electrochromic apparatus in accordance with the invention is disclosed to improve the application thereof

The electrochromic materials are particularly applied to the electrochromic apparatus of the instant disclosure. The electrochromic apparatus includes an aerogel layer with porous structure. The aerogel layer is packaged between a first transparent substrate and a second transparent substrate. A third substrate is furthermore included. The surfaces of the second and third substrates are coated with the conducting materials. Therefore, a first conducting material layer and a second conducting material layer are formed. The property of the packaged electrochromic material can be changed if a voltage is applied to the conducting material layers. The substrate is preferably the glass substrate.

The aerogel has the properties including thermal insulation, vibration absorption, acoustic insulation, light transmissive and dielectric. The electrochromic material provides the effect of discoloration, and also the changes of darkness or transparency.

An outer surface of the third substrate may be coated with a layer of photocatalyst material. A first photocatalyst layer is therefore formed. When the photocatalyst material is illuminated by the ultraviolet within sunlight, the indoor photocatalyst material is then induced to have features of antibacterial, deodorization, and purification. The second photocatalyst layer is formed on the outer side of the first substrate. The outdoor photocatalyst has effect of contamination-proof, and environmental air purification.

According to one of the embodiments, the first substrate is applicably attached with a solar energy power layer, which is used to supply the electric power for the electrochromic apparatus.

In accordance with one further embodiment, the electrochromic apparatus includes the mentioned first substrate and the second substrate. The surfaces of opposite sides of both substrates are respectively formed with the first conducting material layer and the second conducting material layer. An electrochromic composite material layer is packaged there-between. This electrochromic composite material layer is preferably the composite structure of the aerogel and the electrochromic material.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 schematically shows the conventional electrochromic apparatus;

FIGS. 2A to 2G show the schematic diagram illustrating the manufacturing method of the electrochromic apparatus of the embodiment in accordance with the invention;

FIG. 3 shows a schematic diagram of the electrochromic apparatus of one of the embodiments in accordance with the invention;

FIG. 4 shows a schematic diagram of the electrochromic apparatus of one further embodiment in accordance with the invention;

FIG. 5 exemplarily shows the solar power layer in one embodiment;

FIG. 6 shows a schematic diagram of the electrochromic apparatus of third embodiment in accordance with the invention;

FIG. 7 shows another schematic diagram of the electrochromic apparatus of the third embodiment in accordance with the invention;

FIG. 8 shows a schematic diagram of the electrochromic apparatus of fourth embodiment in accordance with the invention.

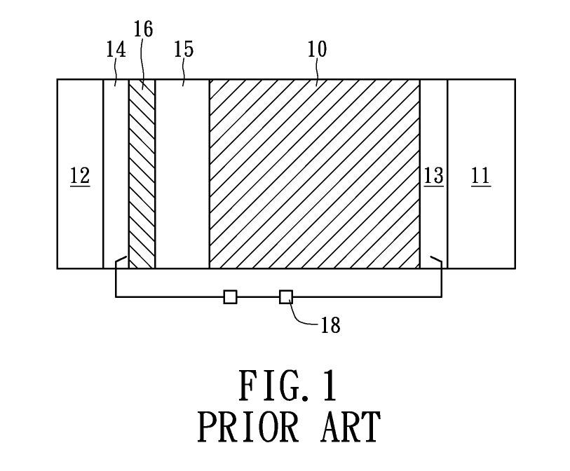

### DETAILED DESCRIPTION OF THE PREFERRED EMBODIMENTS

Energy consumption and environmental protection are the same serious topics to be concerned. It is positive to the environmental protection if any effective resolution to improve the energy consumption has been developed.

One of the objectives of the instant disclosure is to disclose an electrochromic apparatus in this invention which is able to change its transparency as applied with an extra voltage. Any window in application of the disclosed electrochromic apparatus may be used to be a power-saving device for regulating the indoor temperature and light. Therefore, the disclosed apparatus is environmentally friendly to reduce the influence of the environmental heat to the building.

The electrochromic apparatus in accordance with one of the embodiments is a composition of aerogel, electrochromic material, and nano- Titanium dioxide photocatalyst. The fabrication of the composite structure is formed as a transparent device used for windows. This kind of intelligent apparatus provides functions including bactericidal, thermal insulation, acoustic insulation, and light regulation.

Since an electric field or a voltage is applied to the electrochromic material, the main composition thereof is able to change its reflectivity, transmittance and absorptivity. The related electrochromic apparatus provides stable and reversible change of state. For example, the color or transparency of the apparatus is changeable. In general situation, the cations of electrolytic and the electrons of the electrode within the apparatus may be infused into the electrochromic film or moved out of the film when a voltage is applied to the electrochromic film. In the meantime, the state of oxidation of the film material may be changed and result in changing color.

In accordance with one of the embodiments, the electrochromic material layer within the apparatus includes an electrochromic film and an electrolytic layer. The layers may respectively provide electrons and ions, which move within the material as applied with an extra electric field with applied voltage. The apparatus is not only color-changeable, but also with high light transmittance.

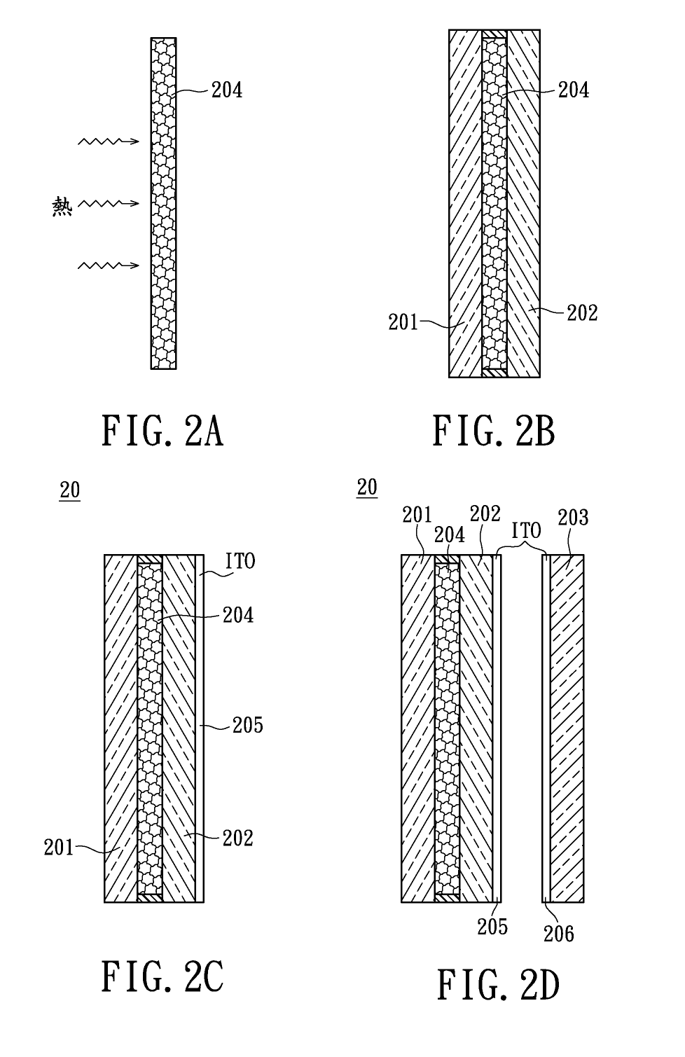

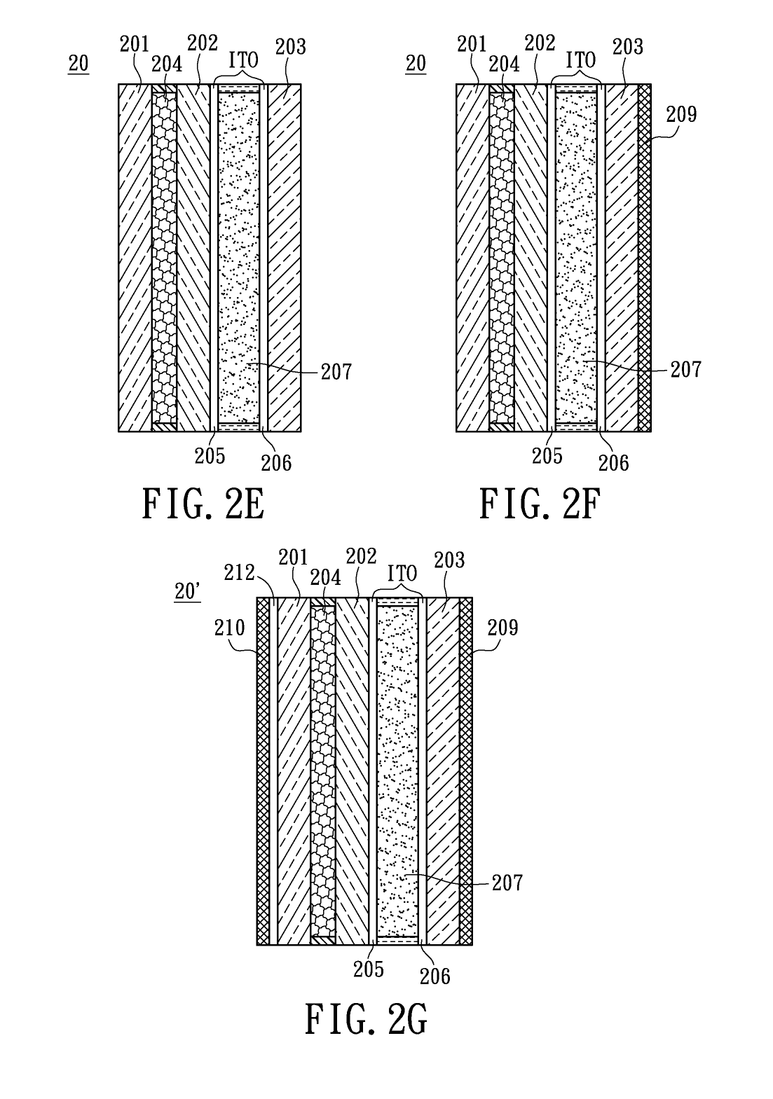

References are made to the embodiments shown in FIGS. 2A to 2G illustrating the method for manufacturing the electrochromic apparatus.

In FIG. 2A, an aerogel layer 204 is firstly prepared. The aerogel layer 204 may be made of hydrophilic or hydrophobic nano silicon-dioxide aerogel or titanium-dioxide aerogel. The aerogel layer 204 is preferably the porous structure. In FIG. 2B, sol-gel of the aerogel is coated upon a surface between a first substrate 201 and a second substrate 202. A drying method may be used to perform the coating. The two ends of the aerogel layer 204 are sealed. In one embodiment, the substrates (201, 202) coated with the silicon- dioxide aerogel undergoes heating process or some surface treatments for enhancing the adhesion between the substrates. The substrates may be glass substrates.

The mentioned first substrate 201 and the second substrate 202 are preferably the glasses. If the substrate is used for building door or window, the substrate is preferably the transparent glass. Therefore, the electrochromic apparatus in accordance with the disclosure may adequately reveal its color-changeable characteristics.

The mentioned aerogel formed on the surfaces of substrates 201, 202 may be coated with an interface-active agent for surface modification. Alternatively, the hydrophilic or hydrophobic aerogel is directly manufactured on the substrates.

Since the aerogel layer 204 is formed between the two substrates 201, 202, such as FIG. 2C, a first conducting material layer 205 is formed on the second substrate 202. The first conducting material layer 205 may be a conductive glass, such as an ITO (Indium tin oxide) coated on the glass.

FIG. 2D schematically shows a third substrate 203 is disposed. The third substrate 203 is also probably the glass. If the apparatus is used for door or window, the substrate is preferably the transparent glass. Further, another conducting material is formed on the third substrate 203. The mentioned second conducting material layer 206 may be the layer formed on the third substrate 203.

In the exemplary embodiment of the electrochromic apparatus in accordance with the invention, the structure formed of the third substrate 203 and the second conducting material layer 206, and the structure made of the first substrate 201, the aerogel layer 204, the second substrate 202, and the first conducting material layer 205 are oppositely fabricated to form the apparatus.

Next, such as FIG. 2E, an electrochromic material is infused into the space between the two structures for forming an electrochromic material layer 207. The electrochromic apparatus is formed after packaging.

It is featured that the electrochromic apparatus 20 is made of the fabrication of the first substrate 201, the second substrate 202, the aerogel layer 204 packaged between the substrates, the first conducting material layer 205 coated on the surface of second substrate 202, and the second conducting material layer 206 coated upon the third substrate 203. The apparatus is especially implemented as a glass having an aerogel layer with nano porous titanium-oxide photocatalyst.

The aerogel layer 204 has effects on thermal insulation, vibration absorption, acoustic insulation, light transmittance, and dielectric properties. The aerogel layer 204 can effectively reduce the outdoor radiation transferred to indoor. The electrochromic material allows changing its color when a voltage is applied to both first conducting material layer 205 and second conducting material layer 206. On the other word, when an electric field is generated within the electrochromic material layer 207, the movement of inside ions and/or electrons serves the apparatus to change its color of material, darkness and/or transparency.

In FIG. 2F, the outer surface of the third substrate 203 is coated with photocatalyst material for forming a first photocatalyst layer 209. When the photocatalyst material is exposed to the ultraviolet of sunlight, the indoor photocatalyst material is induced to have functions including antibacterial, deodorisation, and/or purification. In FIG. 2G, the outdoor photocatalyst is contamination-proof and able to purify the environmental air.

In the exemplary example illustrated in FIG. 2G, a solar power layer 212 is attached with the outer surface of first substrate 201. The solar power layer 212 is used to supply power to the electrochromic apparatus 20′. The outer surface of the first substrate 201 and the solar power layer 212 is coated with the photocatalyst material for forming a second photocatalyst layer 210.

Layers of the electrochromic apparatus can be illustrated as follows:

Aerogel of the aerogel layer 204:

The aerogel is a kind of solid-meshed structure of nano-porous layer with low thermal conductivity. The aerogel also has characteristics of high-surface area and low density, and may be made of organic or inorganic materials. The aerogel has 98 percentage air and is near transparent. In particular, the aerogel is the substance with great thermal insulation among the current solid materials.

Aerogel is porous structure having variously-sized holes. The holes are formed by the tiny contacts among the solid particles in the aerogel. Since the thermal energy is transferred via the solid medium, the transferring path with collisions represents an average free path. The collisions restrain the thermal conductivity via gas, so that the related material has low thermal conductivity coefficient and great effect of thermal insulation.

The selective SiO₂ and carbon are the usual type which is made of high polymer inorganic-metal materials with sol gel. The aerogel may be prepared as monoclinic crystal which has large surface area and high porosity. The aerogel's unique features bring comprehensive applications, such as used for an insulator, acoustic absorber, catalysts supporter, absorbent, and super capacitor. The SiO₂ type aerogel is often used to be the thermal insulation, for example, for resisting around 1000□ temperature. The aerogel may also be made as disk-shaped or brick-shaped structure. However, the aerogel may be not only the inorganic material, but also the organic matter. The composite material composed of organic and inorganic materials is the possible matter for the aerogel. The surface activity of the aerogel may be controllable and be adapted to having the function of hydrophobic or hydrophilic.

The aerogel is featured that it has excellent capability of thermal insulation and low refractive index, namely it has high visibility. The aerogel with high visibility is adapted to the application of electrochromic apparatus in accordance with the instant disclosure.

The materials of electrochromic material layer 207 of the apparatus are as follows.

The electrochromic material is able to absorb light or scatter light as applying a current or an electric field. The color of the electrochromic material is therefore stable and reversible. Since the electrochromic characteristics are found in WO₃ thin film, a lot of electrochromic materials are discovered and constantly developed. The found electrochromic materials include the inorganic transition metal oxides such as TiO₂, Ni(OH)₂, and Ir(OH)₂, organic Viologen, polyaniline, and phthalocyanine, etc.

The electrochromic materials can be categorized into the inorganic electrochromic material and the organic electrochromic material according to the species of the materials. In which, the inorganic electrochromic material is featured that it has stable property. The actions of double-injection and double-extraction of the ions and electrons of the inorganic electrochromic materials induce the changes of optical absorption. On the contrary, the organic electrochromic material owns abundant colors and therefore it is easy to perform molecular configuration. The changes of optical absorption of the organic electrochromic material are caused from oxide-reduction reactions. The viologen is a typical organic electrochromic material.

Viologen is 1,1′-double-substitution-group-4,4′-Bipyridine salt. The Viologen is composed of two N atoms. The altering of oxide reduction states may provide electrons or receive electrons, and therefore two reversible oxide-reduction reactions may be happened. The Viologen has three oxide-reduction states, and the divalent cation of Viologen is at the most stable state. It is featured that the Viologen does not absorb light within visible zone, and does not show color since no any photo-charge transferring happened to the anion.

When the oxide-reduction is in process, free radicals with one-valent cations are produced. The free radical may exist stably since the free radical along the framework of the large conjugated pi-bond of Viologen is delocalized. Furthermore, the transferring between the one-valent N and zero-valent N of the photo charges allows a high molar absorption coefficient, and be with strong coloration. The electronic effect of the substituent group R, R′ on N,N′ may result in high influence of the absorption spectrum. The altering within the Viologen or the like material also results in the change of colors due to the changes of the energy levels of the molecular orbital. The further reduction acquires neutral Viologen with dual reduction state. This neutral Viologen has no the photo-charge transferring with corresponding visible-light spectrum, and has low intensity of colors.

The above-described inorganic electrochromic material is the one selected from the transition-metal oxide group with anodic coloration, cathodic coloration, or cathodic/anodic coloration. The transition-metal oxide with the anodic coloration may be Cr₂O₃, NiOx, IrO₂, MnO₂, Ni(OH)₂, Ta₂O₅, or Fe[Fe(Cn)₆]₃. The transition-metal oxide with the cathodic coloration may be WO₃, MoO₃, Nb₂O₃, TiO₂, SrTiO₃, or Ta₂O₅. The oxide with the cathodic/anodic coloration may be V₂O₂, Rh₂O₃, or CoOx.

Furthermore, the electrochromic material may also be the thin-film type electrochromic material made of a hybrid conductive polymer electrolytic. This hybrid conductive polymer is preferably a Polypyrrole or polyaniline.

An electrolytic layer of the electrochromic material layer 207 is described as follows:

One of the embodiments of the electrolytic layer is a solid electrolytic, which is preferably a Proton Exchange Membrane. Other types of the electrolytic layer may be Ionomer membrane, organic-inorganic hybrid membrane, or Membrane based on polymer and oxo-acids. The ionomer membrane is preferably a polymerized perfluorosulfonic acid (PFSA).

One more liquid electrolytic may be included. This type of electrolytic may be LiCO₄, KOH, NaOH, or Na₂SiO₃.

The photocatalyst includes various types, such as TiO₂, chlorophyll, metal complex (dyes) and the like. Things with capability of absorbing light and inducing catalytic reaction may all categorized to the photocatalyst. In particular, the chlorophyll is well known natural photocatalyst which is an excellent substance to absorb energy of sun light. The chlorophyll particularly is able to transform the carbon dioxide and water into glucosidase, namely the well known photosynthesis. Since the natural substance such as chlorophyll can supply the vital carbohydrate, the chlorophyll is therefore able to eliminate the carbon dioxide on the air. Because the low-cost TiO₂ has stable chemical property and will not hurt the people and the environment, the TiO₂ becomes the most comprehensive artificial photocatalyst.

The described photocatalyst is the material capable of absorbing light and generating catalytic reaction, and is useful under the circumstance with suitable absorption of light. For instance, the photocatalyst material is named nano-photocatalyst when the particle diameter thereof is within the nano-level range of 1 to 100 nanometers. When the absorption of light of the particle of TiO₂ is greater than the optical energy of the energy gap, the electrons may be converted into free electrons as excited from a valence band to a conduction band. After that, an electronic hole with positive charge may be left on the valence band. The electrons in excited state may approach and process reduction reaction with the surface molecules of the photocatalyst particle, and the electrons can be at reduction state. On the other hand, the electronic holes with positive charge may process oxidation reaction with chemical molecules, and the electronic holes are the at oxidation state. Due to the above description, it shows a typical process of photocatalytic reaction when the surface of photocatalyst particle is simultaneously processed with both oxidation and reduction reactions.

For example, when the titanium-dioxide particles process environmental purification on the air, the oxygen and vapor molecules may master the oxidation reduction reaction on the particle surface of the photocatalyst. Since the vapor and the oxygen molecules in the environment separately meet the electron or electronic hole on the surface of the titanium- dioxide particle, the active substances at absorptive state such as the hydroxyl radical (—OH) and negative oxygen ions (O²⁻) thereon can be produced.

Those mentioned active substances with high oxidative capacity can be reacted with the pollutants on the air or in aqueous phase, and the pollutants can be eliminated by oxidation process and decomposing the pollutants into carbon dioxide and water. It is noted that the pollutant may be organic compound, smell, nitrogen oxide or bacterial.

The reaction mechanism applied to the photocatalyst can be categorized into a chemical reaction and a physical reaction. It is noted that the reactions including eliminating the pollutants on the air or in the water, processing synthesis of organic chemistry, or decomposing water for producing hydrogen are related to the chemical reactions such as oxidation or reduction reaction. The porous and thicker coating layer with the photocatalyst may provide more effective areas for proceeding the related reactions among the electrons, electronic holes and the molecules attached on the surface in order to improve the reaction rate.

With respect to the physical reaction, the coating photocatalyst may be the use of self-cleaning, fog-proofing, and rust-proofing. This coating layer may not be too thick since the physical reaction thereof merely relates to the electronic transferring mechanism. Most of the objects to be coated with the photocatalyst are glasses or tiles with smooth surface. The coated photocatalyst would not reduce the light transmittance of the objects, nor change the color or outward appearance of the objects. The physically coated photocatalyst is a uniform thin film around tens or hundreds of nanometers.

In addition to the application of environment purification, the photocatalyst is used to decompose the water into hydrogen and carbon dioxide for producing methyl alcohol which is comprehensively used to be the application of photocatalyst solar battery. In comparison with the well-known silicon-based solar cell, the photocatalyst solar cell is with flexibility. It is highly anticipated that the flexible solar cell may be provided for comprehensive applications since its flexibility may be used for the flexible substrate such as fabrics and plastics.

A transparent solar power opto-electronic plate of the solar power layer 212:

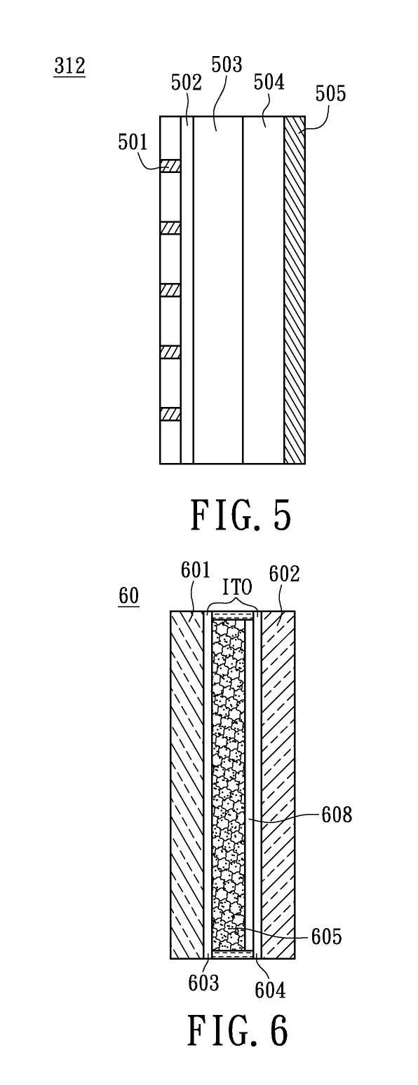

The radiation energy of the sunlight is distributed over a wide range of wavelength. In which, 6% of the radiation is ultraviolet, 50% is visible light, and 44% is infrared. The operation principle of opto-electronic plate uses an effect of excitation of electrons within the pn-junction of semiconductor. FIG. 5 shows the schematic diagram of the example of the invention. The semiconductor can be categorized into p-type and n-type semiconductor according to the plus/minus properties of the inside carriers. Once the p-type semiconductor and the n-type semiconductor are joined, the negative electrons are separated for forming the n-type semiconductor, and the positive electrons are separated for forming the p-type semiconductor. The semiconductor can be excited as radiated by light. In the meanwhile, the electrons with negative charge and the electrons with positive charge can be separated as joining the pn-junction of the semiconductor. The produced electric signals can be extracted out if some consecutive electrodes are connected with the two portions of the semiconductor.

In general, the average amount of light reaching the earth surface in a sunny day is around 1,000 W/m². The describe pn-junction semiconductor opto-electronic plate is designed to react with a specified wavelength range of light. It is therefore difficult to use the energy of whole wavelength range of sunlight. The opto-electronic plate only acquires the electricity at a rate lower than 20%. For example of the conventional silicon semiconductor opto-electronic plate, only energy transferring rate of 7% is obtained. Only energy 70 W/m² can be acquired even in the sunny day.

With respect to the application of the infrared, it is theoretically that a semiconductor element can be designed to independently react with and control the ultraviolet, visible light and infrared if a function of changeable reflectivity is attached to the device with infrared application. Furthermore, the mentioned device may be easily designed for big-sized object and applied to the general household window if the device is manufactured to be a plane glass. The application of the opto-electronic plate installed onto the home glass window for generating electricity may make sure the visibility of the window, and also reflect the infrared to resist the heat conducted to indoor in summer. In winter, the related solar energy sheet may guide the infrared (solar energy) into indoor for purpose of saving energy.

Since the transparent opto-electronic plate utilizes the ultraviolet to generate electric power, the structure of the plate should prevent the various degradations from the damage caused by the ultraviolet. Also, the plate may be easily added with function of infrared reflection. The plate may effectively conduct the thermal insulation. The transparent opto-electronic plate is used to be an important element of the green building in the future since the plate is able to generate electricity, insulate against heat, and be a transparent window.

Some high-priced and high-quality crystalline substrates, such as sapphire with thermostable and isotropic property, are used to manufacture the transparent oxide semiconductors. In consideration of yield cost, zinc oxide semiconductor (n-type) and copper aluminum oxide semiconductor (p-type) are fabricated to form a pn junction.

The transparent opto-electronic plate is constituted of zinc oxide semiconductor, aluminum oxide semiconductor, indium tin oxide (ITO), and transparent glass substrate.

According to the above description relating the aerogel, electrochromic material, photocatalyst, and transparent solar opto-electronic plate, the following embodiments of the electrochromic apparatus are provided.

### First Embodiment

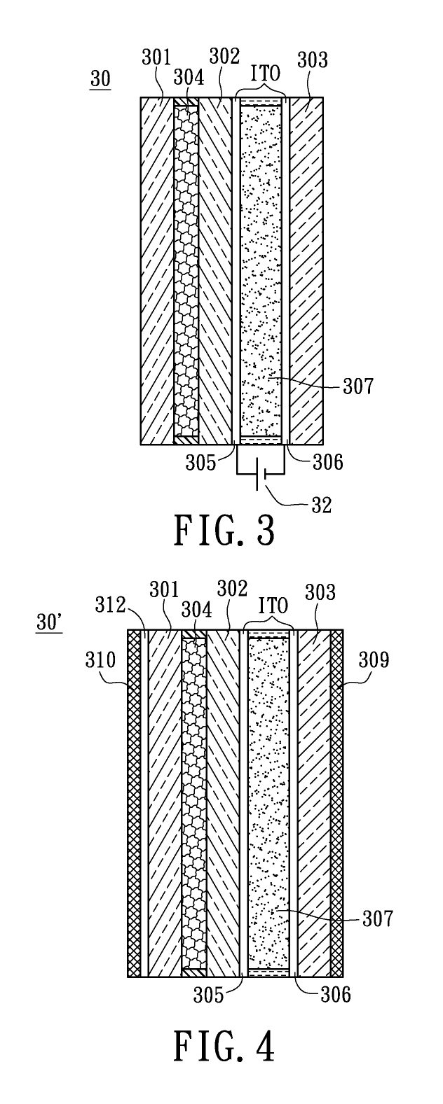

FIG. 3 shows a schematic diagram of the electrochromic apparatus in accordance with one embodiment of the invention.

Left side of the FIG. 3 shows a first substrate 301 and a second substrate 302, and an aerogel layer 304 is packaged between the two substrates. A first conducting material layer 305 is formed upon the other surface of the second substrate 302 opposite to the aerogel layer 304. The first conducting material layer 305 may be an indium tin oxide (ITO) material layer coated on the surface of the second substrate 302. A second conducting material layer 306 is formed on one surface of the third substrate 303. This second conducting material layer 306 may also be the indium tin oxide (ITO) material layer. The second conducting material layer 306 is assembled with the structure of the second substrate 302 and the first conducting material layer 305.

Further, an electrochromic material layer 307 is filled and packaged between the first conducting material layer 305 and the second conducting material layer 306. A voltage source 32 may electrically connect with the first conducting material layer 305 and the second conducting material layer 306 separately. The voltage source 32 supplies voltage to the whole apparatus. The voltage can generate an electric field between the first conducting material layer 305 and the second conducting material layer 306. Therefore, electrons and ions within the electrolytic material of the electrochromic material layer 307 are induced to move. The electrochromic material then conducts light absorption and scattering under the electric field. It is able to change the color or transparency of the electrochromic material in the meantime.

For example, the first substrate 301, the second substrate 302, and the third substrate 303 are transparent glasses. The color or transparency of electrochromic material layer 307 can be changed as applied with voltage. The light-transmittance for the whole electrochromic apparatus 30 can be changed therefore.

In one further embodiment, both outer surfaces of the first substrate 301 and the third substrate 303 can be coated with the photocatalyst layers. The photocatalyst layers may achieve decontamination, purification and sterilization at both indoor and outdoor at the same time.

### Second Embodiment

The voltage source 32 may be provided with the apparatus. Reference is made to FIG. 4 illustrating the embodiment of the electrochromic apparatus.

The apparatus in the diagram includes the first substrate 301, the second substrate 302, and the aerogel layer 304 packaged there-between. The first conducting material layer 305 is formed on the other surface of the second substrate 302. The second conducting material layer 306 is formed on the surface of the third substrate 303. The electrochromic material layer 307 is packaged between the first conducting material layer 305 and the second conducting material layer 306.

The first photocatalyst layer 309 capable of decontamination, purification and sterilization is coated on an outer surface of the third substrate 303. The other surface of the first substrate 301 opposite to the aerogel layer 304 may be attached with a solar power layer 312. The solar power layer 312 is configured to generate electricity as receiving sunlight. The solar power layer 312 is electrically connected with the first conducting material layer 305 and the second conducting material layer 306. As the voltage is applied to both the conducting material layers 305, 306, the electric field is generated to make difference of the electrochromic material layer 307. The additional power may be supplied to other facilities.

A photocatalyst may be coated onto the outer surface of the solar power layer 312 for forming a second photocatalyst layer 310. A first photocatalyst layer 309 is coated the other outer surface of the third substrate 303 opposite to the second conducting material layer 306. The solar power layer 312 may be a transparent solar opto-electronic plate. This transparent solar opto-electronic plate will not affect the light transmittance of the electrochromic apparatus 30′.

One exemplary embodiment of the solar power layer 312 may be referred to the diagram of FIG. 5. The solar energy plate can be a transparent device having a first electrode layer 501 at a light-receiving surface. An antireflection film 502 may be disposed between the first electrode layer 501 and the internal elements. A first semi-conductive material layer 503 and a second semi-conductive material layer 504 are interconnected and disposed between the first electrode 501 and a second electrode layer 505.

In accordance with one embodiment, the operation principle of the solar opto-electronic plate uses an effect of excitation of electrons in the pn-junction of the semiconductor. The first semi-conductive material layer 503 and the second semi-conductive material layer 504 may respectively be an n-type semiconductor and a p-type semiconductor. Once the n-type and p-type semiconductors are joined, the negative electrons are moved apart to be the n-type semiconductor, and the positive electrons are moved to form the p-type semiconductor. When the light radiates the pn junction thereof, the electrons are excited. The movement of the electrons or electronic holes generates electric current which is used to supply power to the electrochromic apparatus.

### Third Embodiment

FIG. 6 shows a schematic diagram illustrating the electrochromic apparatus of third embodiment of in accordance with the invention.

The shown electrochromic apparatus 60 includes a first substrate 601 and a second substrate 602. The apparatus also includes a first conducting material layer 603 and a second conducting material layer 604, which are fabricated to each other at two sides of the apparatus. An electrochromic composite material layer 605 is packaged between the first conducting material layer 603 and the second conducting material layer 604.

In one embodiment, the electrochromic composite material layer 605 is particularly with characteristics of semiconductor. Any abnormal electric signal may be produced as the layer 605 meets the adjacent structure. For example, a shorting problem may be occurred when the electrochromic composite material layer 605 meets the second conducting material layer 604. In an exemplary embodiment shown in the diagram, a spacer 608 may be added between the electrochromic composite material layer 605 and the second conducting material layer 604. The spacer 608 is used to ensure there is no abnormal shorting occurred between the two layers (604, 605). In one further embodiment, the similar spacer or the like may be inserted between the electrochromic composite material layer 605 and the first conducting material layer 603.

The electrochromic composite material layer 605 in the current embodiment combines the aerogel and the electrochromic material. For example, the composite material layer may be the composite structure including Viologen mixed with aerogel, or grafted and polymerized with the surface of aerogel. This kind of composite structure may involve the characteristics of aerogel and electrochromic.

The mentioned aerogel is the material with high dielectric constant, and can have characteristics of semiconductor. The material may therefore supply electrons to function the electrochromic material, such as titanium dioxide or indium tin oxide. Another structure of the aerogel is made of silicon dioxide which is non-conductive, in which the acquired electrons are supplied by the conducting material coated on the surface of substrates.

The hydrophilic and hydrophobic properties of the aerogel can be utilized to be the indoor or outdoor glasses. In application of indoor or outdoor window, the non-titanium dioxide photocatalyst is the major structure to be the porous aerogel. The aerogel is hydrophilic since it needs to conduct photosynthesis.

The aerogel is selected due to the solution property of the electrochromic material if the aerogel is to be one portion of the composite material and between the two conducting glasses such as the first conducting material layer 603 and the second conducting material layer 604. If the aerogel is applied to a water-soluble electrochromic solution, electrolytic, or OH⁻ radical (e.g. water), a hydrophilic aerogel is selected. Otherwise, the hydrophobic aerogel is applied if the electrochromic solution or electrolyte (e.g. γ-caprolactone) is oiliness or hydrophobic.

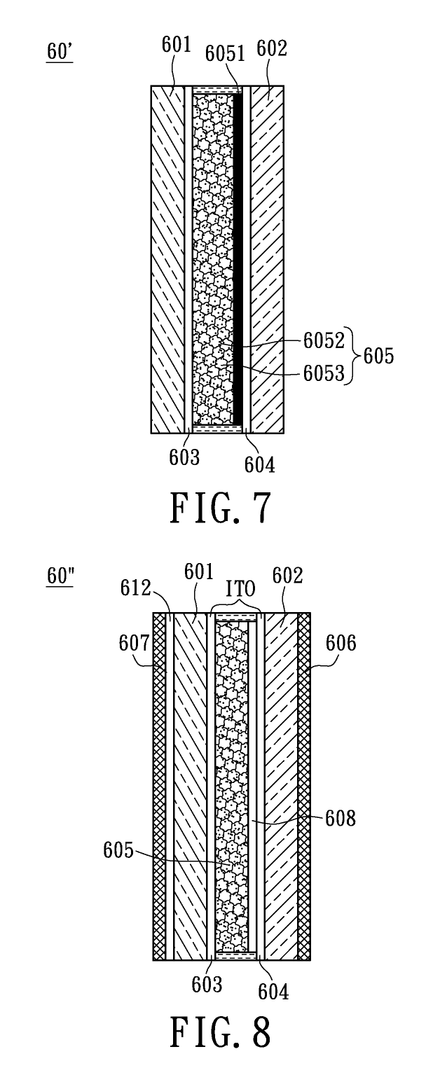

FIG. 7 shows one further embodiment of the invention describing an electrochromic apparatus 60′. In addition to the electrochromic composite material layer 605 with the surface structure mixing the electrochromic material or polermized with the aerogel, this composite material may be plated with inorganic or organic thin-film-type electrochromic material 6051 on the second conducting material layer 604. Exemplarily, the material may be plated between the electrochromic composite material layer 605 and the second conducting material layer 604. Electrolytic material 6052 is allowed to be injected into porous aerogel material 6053.

According to one of the embodiments, the outer sides of the first substrate 601 and the second substrate 602 may be coated with photocatalyst for forming a photocatalyst layer.

### Fourth Embodiment

The diagram shown in FIG. 8 is a schematic diagram of the electrochromic apparatus of the embodiment in accordance with the instant disclosure.

An electrochromic composite material layer 605 is packaged within the first substrate 601 and second substrate 602 of the electrochromic apparatus 60′. The inner sides of the two substrates (601,602) may respectively form the first conducting material layer 603 and the second conducting material layer 604.

In one exemplary example, such as the structure shown in FIG. 6, the electrochromic composite material layer 605 may avoid any abnormal electrical contact with the adjacent structure due to its semi-conductive property. A spacer 608 may be installed between the electrochromic composite material layer 605 and the second conducting material layer 604 for preventing shorting there-between. A similar spacing room may also be installed between the electrochromic composite material layer 605 and the first conducting material layer 603.

The outer surface of the second substrate 602 may form a first photocatalyst layer 606 as coated with the photocatalyst material. The outer surface of first substrate 601 may be installed with a solar power layer 612 for supplying electric power. This solar power layer 612 is electrically connected with the first conducting material layer 603 and the second conducting material layer 604. The power supplied from the solar power layer 612 may generate an electric field between the two conducting materials (603,604), and result in changing the physical property of the electrochromic composite material layer 605.

Further, the outer surface of the solar power layer 612 may be coated with the photocatalyst material and forming a second photocatalyst layer 607.

In addition to the composition of the electrochromic material, including the electrochromic film and electrolytic layer, an entire-liquid-state electrochromic material is introduced. That is, the described electrochromic material layer is filled with this entire-liquid-state electrochromic material. The primary composition of the entire-liquid-state electrochromic material may be organic material or inorganic material which combined with a specific solvent. The entire-liquid-state electrochromic material includes at least one organic material and at least one inorganic material, or a mixture solution with the organic and inorganic materials.

In exemplary embodiments, the above-described organic material may be selected from oxidation-reduction indicator, PH indicator, and some specific organic compounds. The related ingredients are described as follows.

The mentioned oxidation-reduction indicator may be selected from the group consisting of: methylene blue, dichlorobenzenone-indophenol sodium, N-Phenylanthranilic acid, sodium diethenylamine sulonate, N,N′-diphenyl benzidine, and Viologen; the PH indicator may be variamine blue B; the organic compound may be Ferrocene (Fe(C₅H₅)₂), or 7,7,8,8-Tetracyanoquinodimethane.

The inorganic material of the entire-liquid-state electrochromic material may be selected from the group consisting of: oxide, sulfide, chloride and hydroxide. Wherein:

The transition element thereof may be selected from the group consisting of: scandium subgroup, titanium subgroup, vanadium subgroup, chromium subgroup, manganese subgroup, iron, copper subgroup, zinc subgroup and platinum subgroup.

The above described inorganic materials may be selected from the group consisting of: halogen inorganic derivative, oxygen-group inorganic derivative, nitrogen-group inorganic derivative, carbon-group inorganic derivative, boron-group inorganic derivative, alkaline-earth-group inorganic derivative and alkali-group inorganic derivative.

Further, the inorganic material may be selected from the group consisting of: FeCl₂, FeCl₃, TiCl₃, TiCl₄, BiCl₃, CuCl₂, and LiBr.

In one exemplary embodiment, the solvent of entire-liquid-state electrochromic material may ((CH₃)₂SO), (C₄H₆O₃), water, gamma-Butyrolactone, Acetonitrile, Propanenitrile, Benzonitrile, pentanedinitrile, Nitrile-methyl glutaric, 3,3′-Oxybispropanenitrilek, hydroxypropionitrile, Dimethylformamide, N-methylpyrrolidinone, Sulfolane, 3-dimethylsulfolane, or one of the composition thereof.

Furthermore, the entire-liquid-state electrochromic material may be made of a solution dissolved with the electrochromic material. One of the preferred embodiments of the organic electrochromic material is Viologen or phthalocyanine. The difference of Carbon-chain length or structure of R substituent of Viologen results in various colors. The R substituent may be the one selected from the group consisting of: Methyl, Ethyl, Propyl, Butyl, Pentyl, Hexyl, Heptyl, Octyl, Iso-pentyl, and Benzyl. The common Viologen is 1,1′-Dimethyl-4,4′-bipyridinium Dichloride Hydrate (MV), 1,1′-Diheptyl-4,4′-bipyridinium Dibromide (HV), 1,1′-Dibenzyl-4,4′-bipyridinium Dichloride Hydrate (BV), 1,1′-Bis(2,4-dinitrophenyl)-4,4′-bipyridinium Dichloride, 1,1′-Di-n-octyl-4,4′-bipyridinium Dibromide (Octyl), or 1,1′-Diphenyl-4,4′-bipyridinium Dichloride, 4,4′-Bipyridyl.

In summation of the above description, the electrochromic apparatus in accordance with the invention is exemplarily a transparent glass device. This device is packaged, between two layers of conducting materials, with electrochromic material, electrochromic composite material, or a type of entire-liquid-state electrochromic material. The device may be powered by a solar opto-electronic plate. The electric power is supplied to change the transparency or color of the device. The structure of the transparent glass device may be combined with thermal-insulated aerogel and bactericidal photocatalyst with decontamination. A multifunctional electrochromic device is achieved.

The above-mentioned descriptions represent merely the preferred embodiment of the present invention, without any intention to limit the scope of the present invention thereto. Various equivalent changes, alternations or modifications based on the claims of present invention are all consequently viewed as being embraced by the scope of the present invention.

What is claimed is:

1. An electrochromic apparatus, comprising:
a first substrate;
a second substrate ;
a third substrate ;
an aerogel layer, packaged between the first substrate and the second substrate;
a first conducting material layer, formed on the opposite surface of the second substrate with respect to the aerogel layer;
a second conducting material layer, formed on the surface of the third substrate, and the first conducting material layer and second conducting material layer are oppositely combined; and
an electrochromic material layer, packaged between the first conducting material layer and the second conducting material layer.

2. The electrochromic apparatus of claim 1, wherein the electrochromic material layer is filled with an entire-liquid-state electrochromic material or a thin-film-type electrochromic material.

3. The electrochromic apparatus of claim 1, wherein the first substrate, the second substrate, and the third substrate are transparent glasses.

4. The electrochromic apparatus of claim 1, wherein the first conducting material layer and the second conducting material layer are indium-tin-oxide material layers respectively coated on the second substrate and the third substrate.

5. The electrochromic apparatus of claim 1, further comprising a voltage source electrically connected with the first conducting material layer and the second conducting material layer.

6. The electrochromic apparatus of claim 1, further comprising a solar power layer attached with the opposite surface of the aerogel layer with respect to the first substrate.

7. The electrochromic apparatus of claim 6, wherein the solar power layer is a transparent solar opto-electronic plate electrically connected with the first conducting material layer and the second conducting material layer.

8. The electrochromic apparatus of claim 6, further comprising a second photocatalyst layer coated on an outer side of the solar power layer.

9. The electrochromic apparatus of claim 1, further comprising a photocatalyst layer coated on an outer surface of the first substrate.

10. The electrochromic apparatus of claim 1, further comprising a first photocatalyst layer coated on opposite outer surface of the third substrate with respect to the conducting material layer.

11. An electrochromic apparatus, comprising:
a first substrate;
a second substrate ;
a first conducting material layer, formed on one surface of the first substrate;
a second conducting material layer, formed on one surface of the second substrate, and the first conducting material layer and the second conducting material layer are oppositely combined; and
an electrochromic composite material layer, packaged between the first conducting material layer and the second conducting material layer.

12. The electrochromic apparatus of claim 11, wherein the electrochromic composite material layer is composite structure having an aerogel and an electrochromic material.

13. The electrochromic apparatus of claim 12, wherein, in the electrochromic composite material layer, an electrolyte material is injected into porous material of the aerogel.

14. The electrochromic apparatus of claim 12, further comprising an organic or inorganic thin-film-type electrochromic material coated between the electrochromic composite material layer and the second conducting material layer.

15. The electrochromic apparatus of claim 12, wherein, a spacer is between the electrochromic composite material layer and the first conducting material layer, or between the electrochromic composite material layer and the second conducting material layer.

16. The electrochromic apparatus of claim 11, wherein the first conducting material layer and the second conducting material layer are indium-tin-oxide material layers respectively coated on both the first substrate and the second substrate.

17. The electrochromic apparatus of claim 11, further comprising a voltage source electrically connected with the first conducting material layer and the second conducting material layer.

18. The electrochromic apparatus of claim 11, further comprising a solar power layer, which is a transparent solar opto-electronic plate attached to the opposite surface of the first substrate with respect to the electrochromic composite material layer, and electrically connected with the first conducting material layer and the second conducting material layer

19. The electrochromic apparatus of claim 18, further comprising a second photocatalyst layer coated on an outer surface of the solar power layer.

20. The electrochromic apparatus of claim 11, further comprising a first photocatalyst layer coated on opposite outer surface of the second substrate with respect to the second conducting material layer.
